(19) United States
(12) Patent Application Publication
(10) Pub. No.: US 2011/0320416 A1
(43) Pub. Date: Dec. 29, 2011

(54) Eliminating Redundant Processing of Data in Plural Node Systems

(75) Inventors: Neeraj Kapoor, Fremont, CA (US); Prasad S. Mujumdar, Fremont, CA (US); Raghupathi K. Murthy, Union City, CA (US); Ravi C. Pachipala, Fremont, CA (US)

(73) Assignee: INTERNATIONAL BUSINESS MACHINES CORPORATION, Armonk, NY (US)

(21) Appl. No.: 12/822,436

(22) Filed: Jun. 24, 2010

(51) Int. Cl. G06F 17/30

(52) U.S. Cl. 707/692; 707/E17.005

(57) ABSTRACT

According to a present invention embodiment, a system avoids duplicate processing of database objects to ensure operation integrity in a database system including a plurality of nodes. The system comprises a computer system including at least one processor. The computer system receives a data operation from a secondary node, executes the received data operation, and identifies each database object that is relocated based on the executed data operation. The computer system communicates to the secondary node operations performed by the computer system for execution of the data operation and an indication of each relocated database object. The secondary node stores an identifier reflecting the relocation for each relocated database object to prevent re-processing of the relocated database objects for the data operation. Embodiments of the present invention further include a method and computer program product for avoiding duplicate processing of database objects in substantially the same manner described above.

### BACKGROUND

1. Technical Field

The present invention relates to data management in plural node systems, and more specifically, to eliminating redundant processing of data to ensure data integrity and execute UPDATE and MERGE query language statements as intended by a user. This improves the efficiency and complies with a requirement to obey the set operation rules in a relational database system. A present invention embodiment implements the mechanism in multi-node cluster and replicated systems.

2. Discussion of the Related Art

A database system may include a primary server and one or more secondary servers. These servers may perform numerous transactions on data maintained by the database system. Accordingly, data synchronization processes are employed to ensure that the data maintained by the secondary servers is consistent with the data maintained by the primary server. Generally, the primary server performs data transactions originated by the primary server and/or received from the secondary servers. The primary server maintains a log of the operations performed to change the database for the data transactions and sends the log to the secondary servers. Once the secondary servers receive the log, the secondary servers each perform the operations of the primary server contained in the log to enable data maintained by the secondary servers to mirror the data maintained by the primary server. However, the database system may become inefficient and jeopardize data integrity for data transactions when the data transactions relocate data within the database system.

### BRIEF SUMMARY

According to one embodiment of the present invention, a system avoids duplicate processing of database objects in a database system including a plurality of nodes. The system comprises a computer system including at least one processor. The computer system receives a data operation from a secondary node of the database system, executes the received data operation, and identifies each database object that is relocated based on the executed data operation. The computer system communicates to the secondary node operations performed by the computer system for execution of the data operation and an indication of each relocated database object to prevent re-processing of the relocated database objects for the data operation. The system may further include the secondary node that performs the data operation based on the communicated operations, and stores an identifier reflecting the relocation for each relocated database object to indicate database objects that have been processed and to prevent re-processing of those objects for the data operation. Embodiments of the present invention further include a method and computer program product for avoiding duplicate processing of database objects in a database system including a plurality of nodes in substantially the same manner described above.

### BRIEF DESCRIPTION OF THE SEVERAL VIEWS OF THE DRAWINGS

FIG. 1 is a diagrammatic illustration of an example plural node topology employed by a database or other storage system according to an embodiment of the present invention.

FIG. 2 is a diagrammatic illustration of the manner in which data operations are redirected and processed by the system of FIG. 1.

FIG. 3 is a diagrammatic illustration of the manner in which secondary nodes of the system of FIG. 1 relocate database table rows locally in response to a data operation.

FIG. 4 is a flow diagram illustrating a scenario in which data may be redundantly processed for a data operation.

FIG. 5 is a flow diagram illustrating a manner of eliminating redundant processing of data for a data operation.

FIG. 6 is a diagrammatic illustration of the system of FIG. 1 eliminating redundant processing of data for a data operation according to an embodiment of the present invention.

FIG. 7 is a procedural flowchart illustrating the manner in which a secondary node of the system of FIG. 1 performs operations and eliminates redundant processing of data for a data operation according to an embodiment of the present invention.

FIG. 8 is a procedural flowchart illustrating the manner in which a primary node of the system of FIG. 1 performs operations and eliminates redundant processing of data for a data operation according to an embodiment of the present invention.

### DETAILED DESCRIPTION

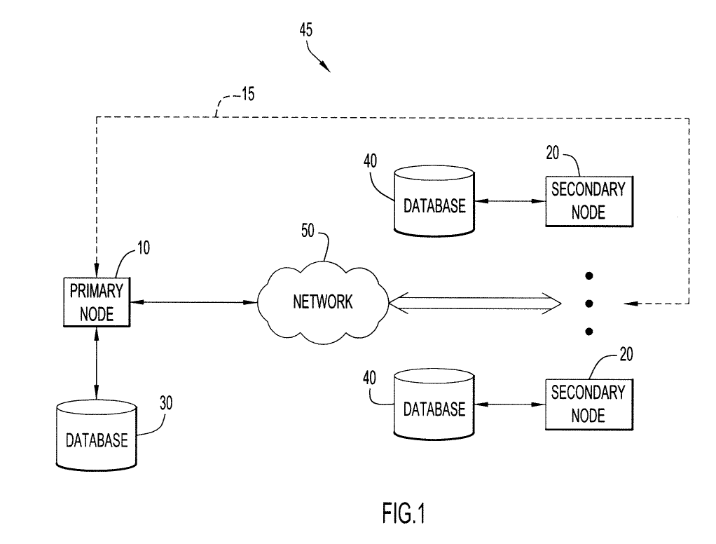

Present invention embodiments pertain to eliminating redundant processing of data within plural node systems for data operations. An example topology employed by a database or other storage system according to an embodiment of the present invention is illustrated in FIG. 1. Specifically, database or other storage system 45 includes a primary node 10 and one or more secondary nodes 20. Primary node 10 may be remote from secondary nodes 20, where the primary and secondary nodes communicate over a network 50. The network may be implemented by any number of any suitable communications media (e.g., wide area network (WAN), local area network (LAN), Internet, Intranet, etc.). Alternatively, primary node 10 may be local to one or more secondary nodes 20 and communicate via communication medium 15. The communication medium may be implemented by any suitable communication media (e.g., local area network (LAN), hardwire, wireless link, Intranet, etc.).

Primary node 10 includes, or is coupled to, a corresponding database 30, and accesses the database to retrieve data for performing various data transactions. The primary node is preferably implemented by a server computer system. Primary node 10 and corresponding database 30 may be local to or remote from each other. Each secondary node 20 includes, or is coupled to, a corresponding database 40, and accesses the database to retrieve data for performing various data transactions. The secondary nodes are each preferably implemented by a server computer system. Secondary nodes 20 and corresponding databases 40 may be local to or remote from each other. The primary and secondary nodes may be implemented by any conventional or other computer systems preferably equipped with a display or monitor, a base (e.g., including the processor, memories and/or internal or external communications devices (e.g., modem, network cards, etc.)), optional input devices (e.g., a keyboard, mouse or other input device), and any commercially available and/or custom software (e.g., server/communications software, software for avoiding redundant processing of data as described below, etc.).

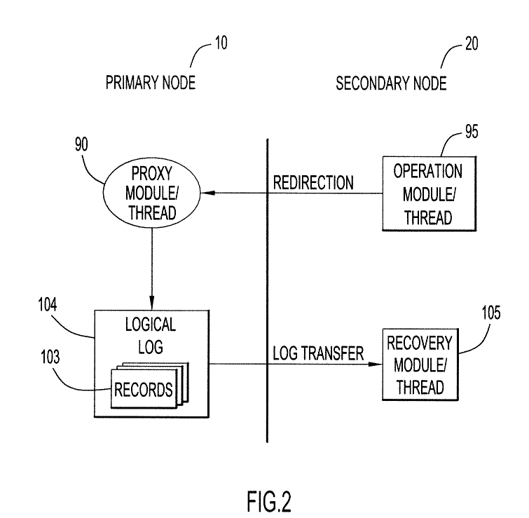

Referring to FIG. 2, each secondary node 20 may perform various data transactions each including one or more data operations (e.g., update, insert, delete, merge, etc.). In order to synchronize the data between database 30 and databases 40 (e.g., maintain consistency of the data between databases 30 and 40) for a data operation, the secondary node redirects the data operation to primary node 10. For example, a data transaction for a table of database 40 may be issued by a user or other application executing on a corresponding secondary node 20. The data transaction includes one or more data operations that may each utilize one or more query language (e.g., SQL, etc.) statements to perform the desired data modification. Secondary node 20 includes an operation module or thread 95 that intercepts the data operation within the query language (e.g., Structured Query Language (SQL)) execution. Information pertaining to the intercepted data operation is stored in an operation structure. The operation structure may include, by way of example, an image of a database table row before performance of the data operation (e.g., prior to modification of the row data), an image of the database table row after performance of the data operation (e.g., after modification of the row data), the data operation, and a complete identification of the row (e.g., a rowid including a partition and identifier for the row). An operation structure for an insert operation may include the row image after performance of the data operation (without the row image prior to the data modification since the row does not exist prior to an insert operation), while the operation structure for a delete operation may include the row image before performance of the data operation (without the row image after the data modification since the row does not exist after a delete operation).

A data operation request including the operation structure is sent from secondary node 20 to primary node 10 over network 50. The primary node includes a proxy module or thread 90 that performs the requested data operation of the transaction on behalf of a session on secondary node 20. The status of the data operation is sent to the secondary node (e.g., for each query language statement executed to perform the requested operation). One or more logs 104 are generated by proxy module 90 of primary node 10 to track the operations performed by the primary node for the requested data operation. The logs include one or more records 103 each including information pertaining to the operations performed by the primary node. By way of example, a log record 103 may include information pertaining to a query language statement performed, a new identification for a processed row, an image of the row before a modification (except for an insert statement), and an image of the row after a modification (except for a delete statement). The logs are replicated and sent to secondary nodes 20. The secondary nodes each further include a recovery module or thread 105 that receives and replays the logs (e.g., performs the operations of primary node 10 indicated in the logs) to synchronize data of databases 40 (corresponding with the secondary nodes) with data of database 30 (corresponding with primary node 10) (e.g., to maintain consistency of data between databases 30 and 40). This provides log replication, where the primary node sends logs of the data modifications to the secondary nodes in order to apply the same data modifications for synchronization.

Secondary nodes 20 may include different types of configurations for redirecting data operations. For example, a secondary node may be configured to share the same disk (e.g., storage or memory disk) as primary node 10 modifying the data. Alternatively, a secondary node 20 may be configured to retain copies of data, where the secondary node maintains the data in synchronization with the data of primary node 10 (e.g., synchronizes a corresponding database 40 with database 30) by replaying the log records as described above. In each of these cases, user or other application requests to modify the data are sent from the secondary nodes 20 to primary node 10.

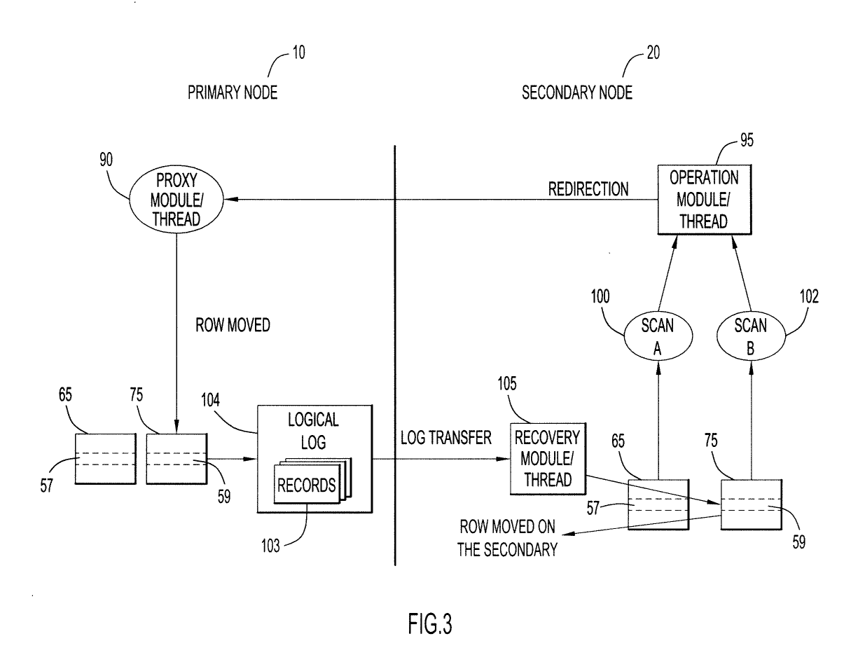

Once a user or other application issues a data operation request for a data transaction on a secondary node resulting in relocation of a database table row, the row is not relocated locally on the secondary node until a corresponding log is received from the primary node and replayed. Referring to FIG. 3 by way of example, a data operation for a data transaction is issued by a user or other application executing on a secondary node 20. The data operation results in a row of a database table being relocated within a corresponding database 40, and operation module 95 initiates a scan 100 (e.g., Scan B as viewed in FIG. 3) to identify a qualifying row 57 for the data operation from a database table or section 65 of a corresponding database 40. The operation module further produces the operation structure with corresponding information for the issued data operation as described above, and sends a data operation request including the operation structure to primary node 10. However, the actual relocation of the row within corresponding database 40 based on the data operation has not been performed by the secondary node.

Proxy module 90 of primary node 10 receives and processes the data operation request, and identified row 57 is relocated from database table or section 65 of database 30 (e.g., corresponding with primary node 10) to a new location 75 as relocated row 59. New location 75 may be within the same or different database table or section of database 30. Proxy module 90 generates a log 104 of the operations performed to process the received data operation request, and sends the log to secondary node 20. Recovery module 105 of the secondary node replays the log (e.g., performs the primary node operations indicated in the log) to relocate row 57 from database table or section 65 within corresponding database 40 to new location 75 as relocated row 59. Thus, the database table row is relocated by the secondary node when logs are received from the primary node and replayed. In other words, the secondary node relocates the row by performing the primary node operations indicated in the logs after the primary node processes the data operation. The log replication to the secondary nodes is asynchronous to the user session on the secondary node initiating and executing the data operation or transaction.

Certain scenarios may enable a database table row to be redundantly processed for a data operation. In other words, the same row may be repeatedly identified and processed for a data operation. For example, an update operation may use an index for a database table to find qualifying rows. If the index key value is updated, this results in movement of the key entry within an index binary tree. Since an update operation requires a table scan to determine qualifying rows, the table scan operation (e.g., using a sequential scan or an index scan) may encounter and qualify a row that has already been updated by the update operation due to the changed index value and location within the binary tree.

Similar scenarios may apply to various operations that modify data (e.g., insert, delete, update, merge, etc.). For example, a merge operation is a Structured Query Language (SQL) operation that merges rows from a source table into a target table. Matching rows in the source and target tables are updated, while unmatched rows from the source table are inserted into the target table. A user may select to update matching rows, and/or insert unmatched rows. The merge operation requires that a row in the target table only be updated once in a merge operation, and that a row inserted into the target table with the merge operation cannot be updated as part of the same operation. This essentially avoids multiple operations on the same row within a given merge operation. In order to accomplish these requirements, the merge operation needs to maintain identifications of updated and inserted rows into the target table to avoid updating the inserted rows in accordance with the merge operation requirements.

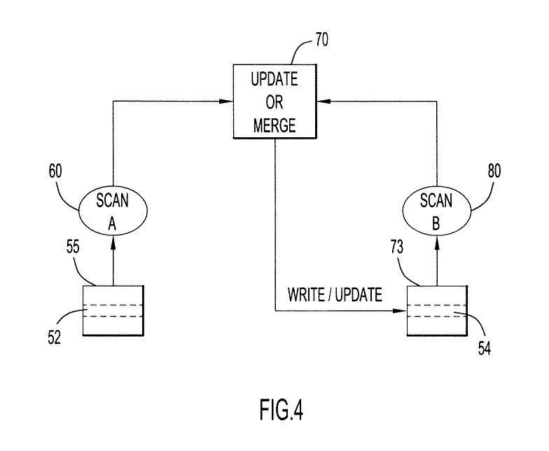

Further, a row may be relocated to a different physical location in response to an operation that changes plural rows. This may occur when table columns specified in a fragment expression are updated in a manner that qualifies the row for another fragment. Referring to FIG. 4 by way of example, a row 52 of a database table or section 55 of a database may be encountered during a scan 60 (e.g., Scan A as viewed in FIG. 4). The row is processed by an update or merge operation 70, and a processed row 54 is placed in a new location 73. Location 73 may be within the same or different database table or section of the database. Another scan 80 (e.g., Scan B as viewed in FIG. 4) may be determining qualifying rows for the same update or merge operation 70, and again encounter row 52 (e.g., as processed row 54 in new location 73) that has already been processed.

This result may occur in configurations that redirect data operations from secondary nodes 20 to primary node 10. For example and referring back to FIG. 3, a data operation for a data transaction is issued by a user or other application executing on a secondary node 20. The data operation results in a row of a database table being relocated within a corresponding database 40, and operation module 95 initiates scan 100 (e.g., Scan B as viewed in FIG. 3) to identify qualifying row 57 for the data operation. The data operation request including the operation structure is produced, and sent to primary node 10 for processing as described above. Proxy module 90 of primary node 10 receives and processes the data operation request, relocates row 57 to new location 75 within database 30 as relocated row 59, and generates log 104 of the operations performed to process the received data operation request. The log is sent to secondary node 20 for replay (e.g., for performing the primary node operations indicated in the log) to relocate row 57 to new location 75 within corresponding database 40 as updated row 59 as described above.

However, another scan 102 (e.g., Scan A as viewed in FIG. 3) may be executing for the same data operation. Since the log replay is asynchronous to the processing of the issued data operation, row 57 may be relocated during identification of qualifying rows by scan 102 in the secondary node. Accordingly, scan 102 may encounter row 57 (e.g., as relocated row 59) that has already been processed by the same data operation.

Moreover, a similar result may occur when there are pending alters that were applied during an update operation without resulting in a row relocation. In this case, a row with a new row identification may be produced within the same fragment. A scan for qualifying rows for the update operation continues, and may again encounter that same row that has already been processed for the update operation.

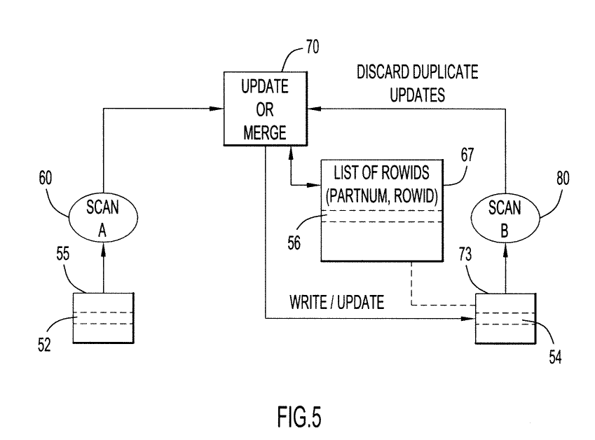

A manner of handling the above scenarios includes placing the row identifications of processed rows in a list. Referring to FIG. 5 by way of example, scan 60 (e.g., Scan A as viewed in FIG. 5) encounters row 52 in a database table or section 55 of a database as described above. Row 52 is processed by an update or merge operation 70, and processed row 54 is placed in a new location 73 as described above. New location 73 may be in the same or different database table or section of the database. However, when row 52 is processed (e.g., updated and/or moved, etc.), a new row identification 56 for processed row 54 is added to a list 67.

Scan 80 (e.g., Scan B as viewed in FIG. 5) may be executing for the same update or merge operation to identify candidate rows qualifying for the operation. However, each candidate row identified by scan 80 is checked against the row identifications in list 67. If the row identification of a candidate row appears in list 67, the candidate row is bypassed. Thus, when scan 80 encounters row 52 (e.g., as processed row 54) that has already been processed by the operation, the row identification for processed row 54 appears in list 67, and processed row 54 is bypassed to avoid redundant processing of that row.

The technique of listing row identifications to avoid redundant processing of rows as described above relies on the availability of a new row identification after the data operation in order to bypass the processed rows. With respect to redirecting the data operation from a secondary node 20 to primary node 10, if a data operation on the secondary node executes for a long time period, the logs from the primary node may be replayed by the secondary node while the data operations are still executing on the secondary node (e.g., scanning to identify qualifying rows for the data operation may still be active). Thus, new row identifications for the processed rows may be unavailable during the continued scanning, thereby enabling processed rows to be identified by the active scans and redundantly processed for the same data operation. In the case of a redirected merge operation, the row identifications of inserted rows are unavailable until the corresponding logs from primary node 10 are received and replayed by the secondary node. This enables inserted rows of the merge operation to potentially be updated which is contrary to the merge operation requirements.

A manner of implementing row identification lists in a plural node topology for redirection of data operations includes synchronously waiting for a list of new row identifications of inserted and/or modified rows in response to redirecting data operations from the secondary nodes to the primary node. However, this technique introduces a negative performance impact due to the waiting time interval.

An embodiment of the present invention implements the row identification lists within a plural node topology for redirection of data operations by retrieving a list of processed rows (e.g., modified and/or inserted rows) from the log replay. This is accomplished by adding intelligence into the asynchronous log communication between primary and secondary nodes, and providing a mechanism to retrieve required information from this log and maintain the list of row identifications in synchronization. The intelligence is provided by incorporating a flag or other indicator and a new row identification in log records. Accordingly, when a log is replayed, a secondary node retrieves the new row identification stored in a log record, and adds the new row identification to a tracking table of the secondary node for the session that is executing the corresponding data operation. The list is utilized to bypass rows that have been processed by the data operation as described below. Since the log replay by the secondary node is asynchronous to the session providing the data operations, there may be instances when the session or the data operation (for which the log records are generated) are completed prior to processing the data operation in the log replay. In these cases, since the processed rows are not scanned for the data operation due to completion of the data operation processing, no further action is taken.

With respect to a merge operation, the rows inserted into the target table need to be tracked in order to avoid updating those rows. Accordingly, the primary node identifies an insert statement that is part of a redirected merge operation, and sets the flag or other indicator in the log records generated for these rows. The mechanism described above adds the identifications of these rows in the tracking table. The operation module or thread utilizes the tracking table to bypass qualifying rows identified from a scan that have been inserted and/or previously processed by the data operation.

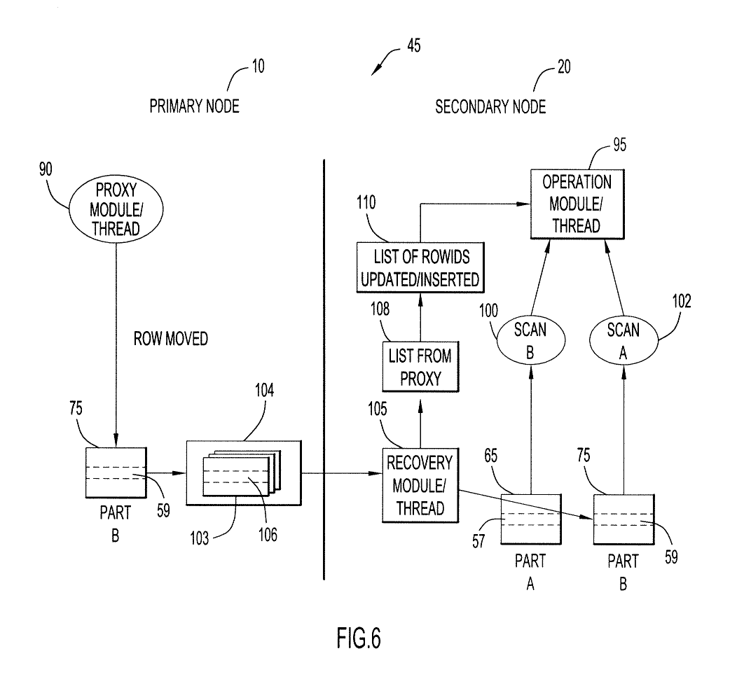

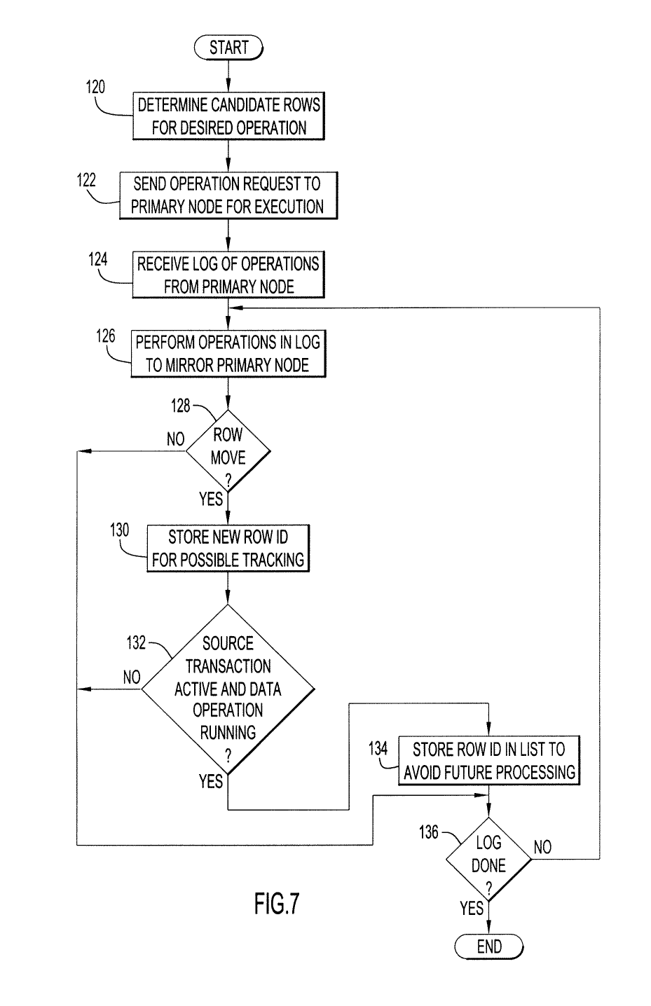

The manner in which a secondary node 20 of database or other storage system 45 processes data operations to eliminate redundant processing of data according to an embodiment of the present invention is illustrated in FIGS. 6-7. Initially, a data operation (e.g., insert, delete, update, merge, etc.) for a data transaction is issued by a user or other application on a secondary node 20. Operation module or thread 95 initiates scans 100 (e.g., Scan B as viewed in FIG. 6), 102 (e.g., Scan A as viewed in FIG. 6) to determine or identify candidate rows or other database objects within database tables or sections 65, 75 of a corresponding database 40 for the data operation at step 120. With respect to a merge operation, the operation module determines or identifies the candidate rows or other database objects, and performs initial processing of an insert operation. By way of example, the data operation may cause a row 57 within database table or section 65 to be relocated to a new location 75 as relocated row 59 within the same or different database table or section of database 40.

The operation module of the secondary node produces the operation structure including the information for the data operation (e.g., row identification, pre and post images of the row, etc.) as described above, and sends a data operation request including the operation structure to primary node 10 at step 122. The operation structure is further stored locally on the secondary node in a proxy transaction structure 108. Proxy module 90 of primary node 10 receives the data operation request, executes the data operation on behalf of the session on secondary node 20, and generates a log 104 (e.g., including statement, new row identification, pre and post images of the row, etc.) as described above to track conditions when a row moves to a new physical location.

When a row does move, a flag or other indicator 106 is set in a log record 103 (e.g., for an update or merge) to indicate the row relocation. The flag may be set to any desired value to indicate this condition (e.g., zero, one, text strings indicating the condition, etc.).

Log 104 is received by secondary node 20 from primary node 10 at step 124, and recovery module 105 performs the primary node operations indicated in the log at step 126 in order to enable data of a database 40 (corresponding with the secondary node) to be mirrored or synchronized with the data of database 30 (corresponding with primary node 10). The recovery module checks for flag 106 within a log record 103 of log 104, and stores the new row identification of a modified or inserted row at step 130 in response to flag 106 being set within the log record as determined at step 128. Recovery module 105 further determines whether a source transaction on the secondary node is still active, and whether the data operation (e.g., update or merge) for that transaction is still executing. If either the source data transaction or data operation have completed as determined at step 132, there is no need to track a row relocation since processed rows are not scanned for the data operation due to completion of processing for that data operation.

When both the data transaction and data operation are active, the row identification is stored in tracking table 110 at step 134 in order for operation module 95 to bypass the processed row during scanning. Basically, operation module 95 compares the identification of candidate rows identified during scanning to the row identifications in tracking table 110. When an identification of a candidate row is present in the tracking table, the candidate row is bypassed as having been processed by the data operation. The above process repeats to process additional operations in the log as determined at step 136.

In the case where recovery module 105 cannot directly access tracking table 110 (since different modules or threads may handle operation processing and log replay or recovery), modifying the tracking table may require that the query language (e.g., SQL) execute context which is not available to recovery module or thread 105. Thus, the row identification is stored in local proxy transaction structure 108. Recovery module 105 moves the row identification list from proxy transaction structure 108 to tracking table 110. Once tracking table 110 is current, operation module 95 filters or bypasses the duplicate or previously processed rows to prevent redundant processing as described above.

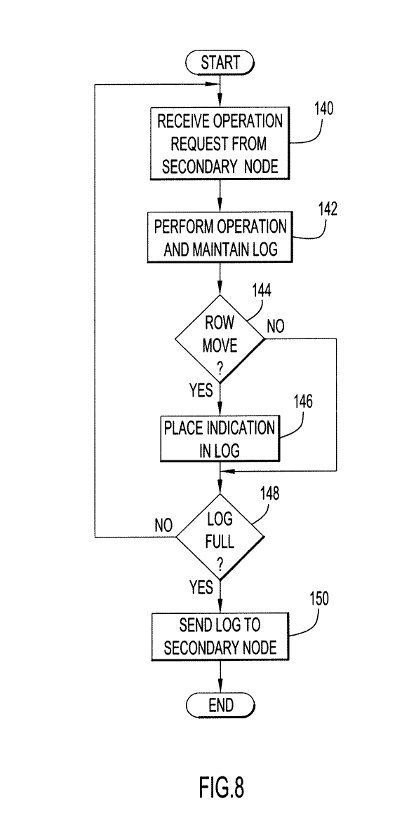

The manner in which primary node 10 of database or other storage system 45 processes data operations to eliminate redundant processing of data according to an embodiment of the present invention is illustrated in FIGS. 6 and 8. Initially, a user or other application executing on a secondary node 20 issues a data operation (e.g., insert, delete, update, merge, etc.) for a data transaction. The secondary node sends a data operation request including the operation structure for the data operation to primary node 10 as described above, and the primary node receives the data operation request at step 140. Proxy module 90 on primary node 10 processes the data operation request, executes the data operation of the data transaction on behalf of the session on secondary node 20, and generates log 104 at step 142 to track the conditions when a row moves to a new physical location. A row move or relocation is preferably handled for an update operation by converting this operation into a deletion of the original row followed by an insertion of a new row with the desired data. In other words, an update operation preferably includes a delete statement to remove the original row followed by an insert statement to insert a new row with the desired data. By way of example, detection of a row move or relocation may be accomplished by a low level or other routine of primary node 10 that performs a disk write operation or, in the case of a merge operation, by a higher level routine of primary node 10 that processes that merge operation.

When a row does move as determined at step 144, the proxy module sets flag or indicator 106 in a log record 103 of log 104 that is generated for the insert portion of the data operation at step 146. Flag 106 is set when the data operation spans more than a batch. In particular, secondary nodes 20 typically batch their data operation requests (e.g., insert, update, delete, merge, etc.) to primary node 10. The batch typically accommodates a certain quantity of rows or modifications. For example, basic Online Transaction Processing (OLTP) statements typically update a few rows, while data loading/updating (ETL/ELT) jobs include significantly more updates within a statement. If a batch contains data modifications for the entire data operation, the log replay occurs after scanning has been completed, thereby avoiding redundant processing of rows. The present invention embodiment invokes the mechanism or flag when the data operation requests span beyond a single batch. In this case, scanning for the data operation may be active, and the row identifications are needed to bypass processed rows. In addition, flag 106 is set within a log record 103 that is generated when an insert operation is performed by proxy module 90 as part of a merge operation.

Once the log is completed as determined at step 148, the primary node sends the log to secondary node 20 at step 150. The secondary node determines the state of flag 106 during log replay to update row identifications within tracking table 110 in order to bypass processed rows as described above.

It will be appreciated that the embodiments described above and illustrated in the drawings represent only a few of the many ways of implementing embodiments for eliminating (or significantly reducing) redundant processing of data in plural node systems.

The topology of the present invention embodiments may include any number of computer or other processing systems (e.g., primary servers, secondary servers, end-user systems, etc.) and databases or other storage units arranged in any desired fashion, where the present invention embodiments may be applied to any desired type of computing environment (e.g., cloud computing, client-server (e.g., the primary server serving as the server with the secondary server serving as the client), network computing, etc.). The computer or other processing systems employed by the present invention embodiments may be implemented by any number of any personal or other type of computer or processing system (e.g., IBM-compatible, Apple, Macintosh, laptop, personal digital assistant, mobile computing devices, etc.), and may include any commercially available operating system (e.g., Windows, OS/2, Unix, Linux, etc.) and any commercially available (e.g., server software, etc.) or custom software (e.g., proxy module, recovery module, and other software for eliminating redundant processing of data, etc.). These systems may include any types of monitors and input devices (e.g., keyboard, mouse, voice recognition, etc.) to enter and/or view information.

It is to be understood that the software (e.g., proxy module, recovery module, and other software for eliminating redundant processing of data, etc.) for the computer systems of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among various end-user, primary, and secondary server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments (e.g., proxy module, recovery module, and other software for eliminating redundant processing of data, etc.) may be available on a recordable medium (e.g., magnetic or optical mediums, magneto-optic mediums, floppy diskettes, CD-ROM, DVD, memory devices, etc.) for use on stand-alone systems or systems connected by a network or other communications medium.

The communication network may be implemented by any number of any type of communications network (e.g., LAN, WAN, Internet, Intranet, VPN, etc.). The computer systems of the present invention embodiments (e.g., primary and secondary servers, etc.) may include any conventional or other communications devices to communicate over the network via any conventional or other protocols. The computer systems (e.g., primary and secondary servers, etc.) may utilize any type of connection (e.g., wired, wireless, etc.) for access to the network. The communication media may be implemented by any suitable communication media (e.g., local area network (LAN), hardwire, wireless link, Intranet, etc.).

The databases may be implemented by any number of any conventional or other databases, data stores or storage structures (e.g., files, databases, data structures, data or other repositories, etc.). The databases may be remote from or local to each other, and/or the server systems (e.g., the primary and secondary servers, etc.).

The log records and log may include any desired information pertaining to the operations performed by the primary node for the data operation. The log record may include information pertaining to any quantity of operations performed by the primary node, or any quantity of operations requested by the secondary node. The log may include any quantity of log records arranged in any desired fashion. The log record may include any desired format or arrangement, and be implemented by any conventional or other record or other data structures (e.g., record, array, file, etc.). The logs may include records for any quantity of any desired operations, where the operations may be grouped in any fashion based on any suitable criteria (e.g., by operation type, execution information, parameters, database object, etc.).

The data operation request may include any desired information pertaining to the operations requested by the secondary node. The data operation request may include any quantity of operation structures arranged in any desired fashion. The data operation request may include any desired format or arrangement, and be implemented by any conventional or other record or other data structures (e.g., record, array, file, etc.). The data operation request may include any quantity of operation structures, where the operations may be grouped in any fashion based on any suitable criteria (e.g., by operation type, execution information, parameters, database object, etc.).

The operation structure may include any desired information pertaining to the data operation requested by the secondary node. The operation structure may include any desired format or arrangement, and be implemented by any conventional or other record or other data structures (e.g., record, array, file, etc.). The operation structure may include information for any quantity of any desired operations, where the operations may be grouped in any fashion based on any suitable criteria (e.g., by operation type, execution information, parameters, database object, etc.).

The proxy transaction structure may include any desired information pertaining to the list of processed rows or other objects (e.g., identifiers, object content, pre and post images of the object, etc.). The proxy transaction structure may include any desired format or arrangement, and be implemented by any conventional or other record or other data structures (e.g., record, array, file, database table, etc.).

The tracking table may include any desired information pertaining to the list of processed rows or other objects (e.g., identifiers, object content, pre and post images of the object, etc.). The tracking table may include any desired format or arrangement, and be implemented by any conventional or other record or other data structures (e.g., record, array, file, database table, etc.).

The row identification may be any identifier capable of uniquely identifying a row, and include any desired information to form the identifier (e.g., partition, sequential or random number, descriptive or other text strings, table field, etc.). An object move may be detected by any conventional or other techniques (e.g., addresses, identifications, fields, etc.).

The present invention embodiments are not limited to the specific database objects and operations described above, but may be applied to any suitable database objects (e.g., tables, rows, columns, other object attributes, etc.) or operations (e.g., merge, join, update, delete, insert, etc.). The data transactions may be any suitable operations or transactions to enter, remove, or modify data or database objects. The database transactions may include any quantity of database operations to perform the desired transactions, where a database operation may utilize any quantity of query language statements to perform a data operation. In addition, the present invention techniques may be applied to any database, storage or other system that synchronizes data or maintains redundant data. For example, the present invention techniques may be applied to shared-disk and mirrored database architectures.

The flag may be any conventional or other indicator to indicate the presence of a moved database object, or any other condition. The flag may be placed at any desired locations within any quantity of log records. For example, the flag may be set in any quantity of the records associated with a data operation or data transaction. The flag may be of any desired length, and include any suitable characters or symbols (e.g., alphanumeric, punctuation or other symbols, etc.). The flag may be set to any desired values to indicate the presence or absence of a relocation or other condition for a database object. Any quantity of flags may be utilized to indicate a desired condition.

The requested data operations from the secondary nodes may be batched in any desired fashion, where each batch may include any desired quantity of rows or other database objects and be arranged in any fashion. The requested operations may span any quantity of batches, where the flag is preferably set in response to an operation spanning more than one batch. However, the flag may be set in response to a data operation spanning any quantity of batches.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including” and the like when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of avoiding duplicate processing of database objects in a database system including a plurality of nodes comprising:
receiving a data operation from a secondary node at a primary node of said database system;
executing said received data operation at said primary node and identifying each database object that is relocated based on said executed data operation;
communicating to said secondary node operations performed by said primary node for said data operation and an indication of each said relocated database object; and
performing said data operation at said secondary node based on said communicated operations and storing an identifier reflecting said relocation for each relocated database object to indicate database objects that have been processed and to prevent re-processing of those objects for said data operation.

2. The method of claim 1, wherein said data operation includes one of an update operation and a merge operation.

3. The method of claim 1, wherein said database object includes a row of a database table.

4. The method of claim 1, wherein said communicating to said secondary node includes:
producing a log of said operations performed by said primary node for said data operation, wherein said log includes one or more log records each pertaining to a database object; and
storing an indicator in a log record corresponding to a relocated database object to indicate relocation of that database object.

5. The method of claim 4, wherein said data operation spans one or more batches received at said primary node, and said storing said indicator includes:
storing said indicator in said log record in response to said data operation spanning a plurality of said batches.

6. The method of claim 1, further including:
identifying database objects for said data operation at said secondary node;
comparing an identifier of each said identified database object to said stored identifiers of said relocated database objects; and
bypassing each identified database object with said identifier matching one of said stored identifiers of said relocated database objects to prevent re-processing of said relocated database objects for said data operation.

7. A computer program product for avoiding duplicate processing of database objects in a database system including a plurality of nodes comprising:
a computer readable storage medium having computer readable program code embodied therewith, the computer readable program code comprising computer readable program code configured to:
receive a data operation from a secondary node at a primary node of said database system;
execute said received data operation at said primary node and identify each database object that is relocated based on said executed data operation; and
communicate to said secondary node operations performed by said primary node for said data operation and an indication of each said relocated database object to prevent re-processing of said relocated database objects for said data operation.

8. The computer program product of claim 7, wherein said computer readable program code includes computer readable program code configured to:
perform said data operation at said secondary node based on said communicated operations and store an identifier reflecting said relocation for each relocated database object to indicate database objects that have been processed and to prevent re-processing of those objects for said data operation.

9. The computer program product of claim 7, wherein said data operation includes one of an update operation and a merge operation.

10. The computer program product of claim 7, wherein said database object includes a row of a database table.

11. The computer program product of claim 7, wherein said communicating to said secondary node includes:
producing a log of said operations performed by said primary node for said data operation, wherein said log includes one or more log records each pertaining to a database object; and
storing an indicator in a log record corresponding to a relocated database object to indicate relocation of that database object.

12. The computer program product of claim 11, wherein said data operation spans one or more batches received at said primary node, and said storing said indicator includes:
storing said indicator in said log record in response to said data operation spanning a plurality of said batches.

13. The computer program product of claim 8, wherein said computer readable program code includes computer readable program code configured to:
identify database objects for said data operation at said secondary node;
compare an identifier of each said identified database object to said stored identifiers of said relocated database objects; and
bypass each identified database object with said identifier matching one of said stored identifiers of said relocated database objects to prevent re-processing of said relocated database objects for said data operation.

14. A system for avoiding duplicate processing of database objects in a database system including a plurality of nodes comprising:
a computer system including at least one processor configured to:
receive a data operation from a secondary node of said database system;
execute said received data operation and identify each database object that is relocated based on said executed data operation; and
communicate to said secondary node operations performed for execution of said data operation and an indication of each said relocated database object to prevent re-processing of said relocated database objects for said data operation.

15. The system of claim 14, further including said secondary node, wherein said secondary node includes a computer system with at least one processor configured to:
perform said data operation based on said communicated operations and store an identifier reflecting said relocation for each relocated database object to indicate database objects that have been processed and to prevent re-processing of those objects for said data operation.

16. The system of claim 14, wherein said data operation includes one of an update operation and a merge operation.

17. The system of claim 14, wherein said database object includes a row of a database table.

18. The system of claim 14, wherein said communicating to said secondary node includes:
producing a log of said operations performed by said computer system for said data operation, wherein said log includes one or more log records each pertaining to a database object; and
storing an indicator in a log record corresponding to a relocated database object to indicate relocation of that database object.

19. The system of claim 18, wherein said data operation spans one or more batches received at said computer system, and said storing said indicator includes:
storing said indicator in said log record in response to said data operation spanning a plurality of said batches.

20. The system of claim 15, wherein said at least one processor of said secondary node is further configured to:
identify database objects for said data operation;
compare an identifier of each said identified database object to said stored identifiers of said relocated database objects; and
bypass each identified database object with said identifier matching one of said stored identifiers of said relocated database objects to prevent re-processing of said relocated database objects for said data operation.
